(19) United States
(12) Patent Application Publication
(10) Pub. No.: US 2011/0252322 A1
(43) Pub. Date: Oct. 13, 2011

(54) DOWNLOADABLE APPLICATION FOR PROVIDING INTERACTIVE MUSIC MIXING SOFTWARE ON A CELL PHONE OR THE LIKE

(75) Inventor: Patrick A. Roberts, Los Angeles, CA (US)

(73) Assignee: MIT TECHNOLOGY GROUP, CORP., Wilmington, DE (US)

(21) Appl. No.: 13/033,770

(22) Filed: Feb. 24, 2011

Related U.S. Application Data
(60) Provisional application No. 61/321,580, filed on Apr. 7, 2010.

(51) Int. Cl. G06F 3/01

(52) U.S. Cl. 715/716

(57) ABSTRACT

A method and system for selecting portions of different songs and mixing the same to create a re-mix which can be played back or used as a ring tone, or sent to another person. A cell phone may be used for mixing the preselected song portions and playing back the re-mixed song portions.

### RELATED APPLICATION

This application claims the benefit of and priority to U.S. Provisional Application Ser. No. 61/321,580 filed Apr. 7, 2010, the content of which is incorporated by reference herein in its entirety.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### BACKGROUND OF THE INVENTION

1. Field

The invention relates to applications for cell phones or the like allowing a user to mix a plurality of segments of songs and replay the same.

2. Description of Related Art Including Information Disclosed Under 37 C.F.R. 1.97 and 1.98

Applications specifically written for cell phones or the like have become extremely popular. Music, such as downloading and replaying songs, is high on the list of popularity. In recent years, disc jockeys and others have mixed excerpts from different songs to create an entirely new “mix.”

### BRIEF SUMMARY OF THE INVENTION

It is an object of this invention to provide an interactive music file format using mobile mixing software for use on a cell phone or the like, or any other similar object, such as a computer, a personal digital assistant (PDA), a tablet computer, etc.

These and other objects are preferably accomplished by providing a method and system for selecting portions of different songs and mixing the same to create a re-mix which can be played back, or used as a ring tone, or sent to another person. A personal digital assistant, such as a cell phone, may be used for mixing the pre-selected song portions and playing back the remixed portions.

### BRIEF DESCRIPTION OF SEVERAL VIEWS OF THE DRAWINGS

FIG. 1 is a flow chart illustrating the process of the invention beginning with licensed songs converted by software into a consumer ready product;

FIG. 2 is a flow chart illustrating various uses of the invention; and

FIG. 3 is a plan view of the face of a cell phone.

### DESCRIPTION OF THE PREFERRED EMBODIMENT

The invention is directed to an audio file format system that is an Interactive Music File Format. Prior to now, all music formats are linear in nature and are designed to play front to back, start to finish. The audio format is used in a mobile music mixing software system.

The user makes mixTONEs (their own mixes) directly using the keys of their mobile phone handset or any personal digital assistant (PDA). The system herein allows the user to remix the samples themselves through direct individual self-choice, individual sample placement, rearranging, and truncating samples provided by the licensed music artist/label. The users can then send their new mixTONEs “remixes” via MMS directly to their friends' mobile phone, a specific website, and their own mySpace, Facebook, etc., or other social networking sites. They can be previewed on the website and on their mySpace, Facebook, etc., or other social networking sites.

The system provides checks and balances so that, in order for the next user to listen to or REMIX their friends' tracks directly on their own phone, that new user must purchase the original source mixPACK created by the original user. That user can in turn resend back to the original friend or onto other friends, or postings on the social networking and myRMX internet sites hosting the various re-mixes (myRMX).

As a value added, mixTONEs can be saved for use as ringtones on the users' phone for phone personalization.

Ringtones made from user mixTONEs can be sold to any mobile phone user regardless of whether they own the rights to the system disclosed herein.

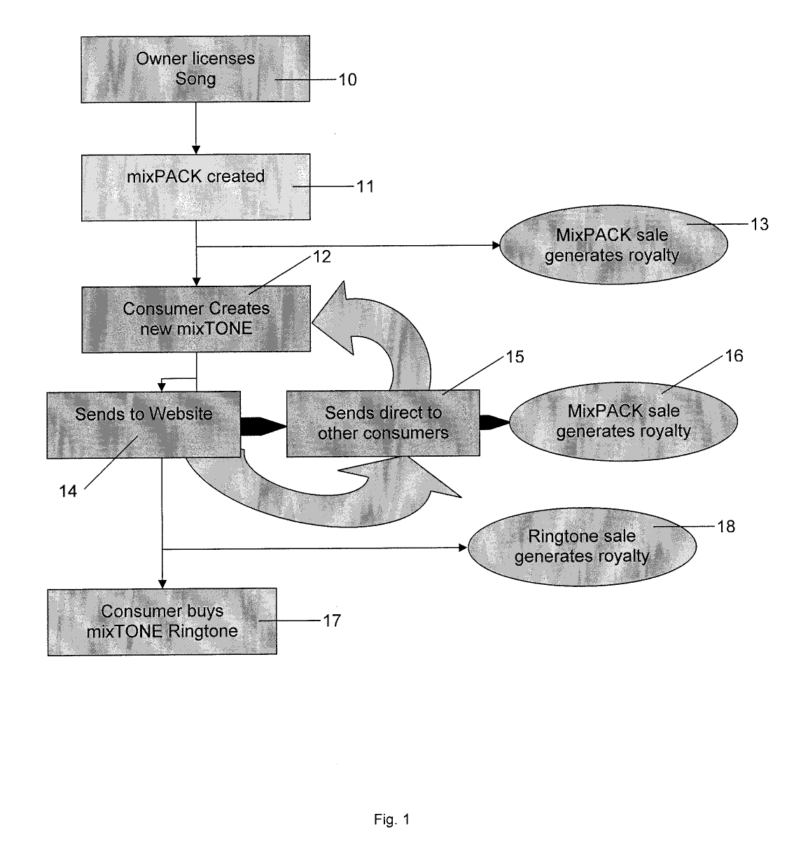

Thus, referring to FIG. 1, the owner of the song or songs in box 10 licenses a number of songs and installs the same on a mixPACK (box 11) created by a 3^{rd} party. The mixPACK is a device for storing the purchased, licensed songs so re-mixes to be made by the user or consumer box 12. This mixPACK sale generates royalties back to the rights owner in box 10 as indicated in bubble 13.

The user in box 12 creates his or her re-mix as a new mixtone which can be sent to a website 14 where the mixtone can be sent to other consumers (box 15) for downloading where again royalties can be generated (bubble 16). From website 14, the mixTONE can be provided in the form of a ring tone (box 17) sold to the consumer in box 12, the ring tone sale generating a royalty (bubble 18).

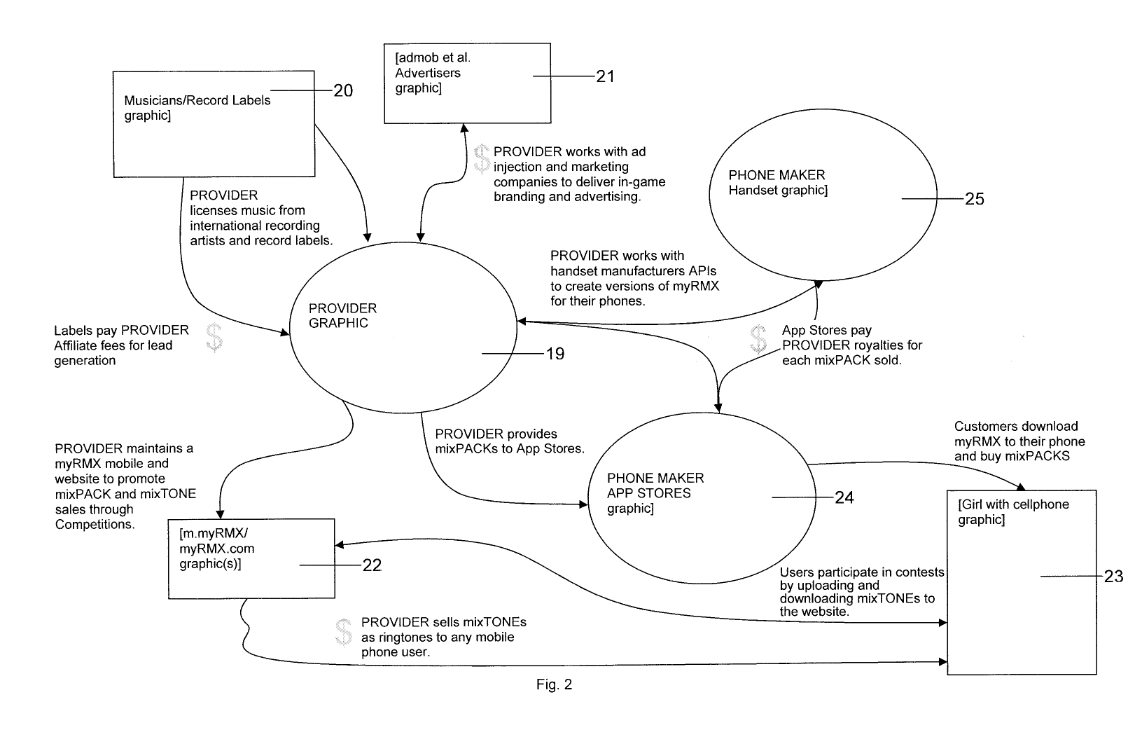

As seen in the flow chart in FIG. 2, a graphic of the provider of the mixPACK is illustrated in bubble 19. The provider licenses music from various sources, such as the musicians/record labels in box 20 and Advertisers (box 21). Provider works with ad injection and marketing companies in box 21 to deliver in-game branding and advertising. The provider sets up a myRMX website (box 22) and sells ring tones from that site to box 22 (any mobile phone user). Provider also provides mixPACKS to App stores (bubble 221) and interfaces with the phone manufacturer in bubble 25.

### SUMMARY

The invention herein is a software application which is designed to work on personal assistant devices, such as any suitable handheld device, as a cell phone, or even set-top boxes. After accessing the software, the user can download from a website the sequencer style, based music mixing software, which allows all users including non-musicians to rearrange, integrate, and personalize the presented proprietary “mix-packs” which are offered as both free demonstration selections as well as premium artist and musical groups for sale. These “Mix packs” can be downloaded onto the software provided for immediate availability of the user's enjoyment. This can be accomplished merely by selecting one of the interface buttons, Load, Mix or Save, or by activating the menu of song selections listed in the body of the art contained in/on the “downloaded” software program. The multi activation buttons and keys become sequentially available as the selected Mix PACK is loaded and the chosen Mix PACK is ready to be manipulated, so as to utilize the proprietary interface-remixing interface. It resembles a racetrack in which each of the supplied “Tracks” may be activated or silenced, at the virtually unlimited combinations of placement and repeatability within the proscribed MIX PACK Sampling provided for each existing selected audio MIX PACK.

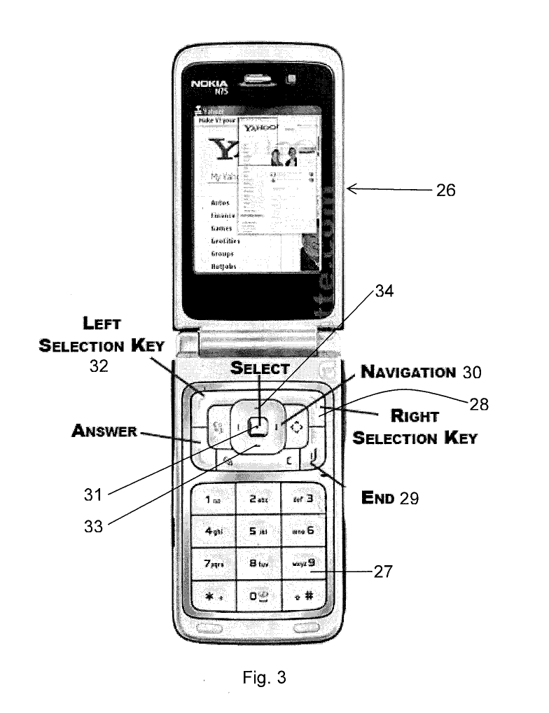

After starting the application, the user is presented with a list of the songs either for a free sample or specifically purchased MIX PACKS they have purchased, along with audio previews of each song. As one example of use with a cell phone, the user selects one (or more) songs they wish to load, using phone 26 in FIG. 3, simply by hi-lighting the selection, and then pressing the load button directly or by activating the same through the cell phone keys 27. Songs are stored in a format consisting of a number of individual audio elements which together comprise the song and meta-data necessary for rearranging and integrating each piece of audio with other pieces of audio. After selecting the song, the user may select from any number of pre-determined collections of sound elements, or choose to make their own. In addition, they may also choose to load each newly completed or existing completed arrangement and to “save” via the same way of activating as the “Load” button previously mentioned, for later session or to make further changes and enhancements, or exit, or editing with a new arrangement.

If the user selects an existing arrangement, the user is then given the option to save the arrangement, or edit the arrangement.

When editing an arrangement, the user is presented a selection of sound groupings or “tracks” which are composed of one or more sound elements. A timeline is also provided to the user. The user creates an arrangement of the sound elements in each sound group on the timeline. They can do this both in real-time or by stepping one time slice at a time making edits. Once a user is has completed editing, they can optionally add their own voice atop their arrangement.

To save an arrangement, the user optionally provides their name and names their arrangement. The arrangement is saved in two formats: firstly in a digital audio format and secondly in a designated file, called a mixTONE, which contains an instruction set and meta-data, but no digital audio data.

The user can then share their mixTONE file with others via peer-to-peer (device-to-device) systems or using a networked server.

### Example

The following is an example of using the teachings of the invention, designated my RMX or RMX with Nokia® cell phones. Although an N-75 Nokia® phone is illustrated in FIG. 3, Nokia's® E-65, N78, N95, etc. cell phones will be very similar in operation as the OS is the same.

The Power Button is on top center of the closed handset where the phone handset hinges or slides open.

Here are the particulars of the Nokia® phones. Over 300 Million Nokia® phones run Symbian OS. All Symbian phones use the Right Selection Key 28 as a BACK, EXIT, ABORT, QUIT, or PREVIOUS key depending on software. If one gets stuck . . . they can try the Right Selection Key and see if that backs them out. One presses and holds it and the application should quit. Most OS software has “on screen” prompts just above the soft keys. One can also hit the RED, end call key 29 to quit the program.

The myRMX™ icon can be highlighted by using the navigation keys 30 and then press the center selection button 31; myRMX will launch.

A tutorial would automatically launch if one was a first time purchaser. First time users would just play around with the software until they figure it out . . . that is half the fun, to explore the new software and figure things out.

The Tutorial is also available via the Left Selection Key 32 (top left button on the face of the keypad 27.) This provides basic commands. However, a purchaser would get a Read Me or email with further instructions and can see YouTube videos and instructional videos on the myRMX.com website (box 22—FIG. 2).

Let the Splash Screen play and then you will get the Main Menu page. The Splash screen can say, Ford®, Coke®, Trident Productions® you name it. Many graphics are interchangeable between the mix packages of the invention.

On the Main Menu, one uses the Navigation keys 30 to move the white highlight over the Load, Mix or Save buttons . . . or press the Hot Keys 1, 2 and 3 for Load, Mix and Save.

Press 1 for the Load screen . . . software slides to the left screen . . . here you can navigate through the mix packages available. A mix package may contain 1 or 2 artist mixes plus the 20-30 samples.

For example, SELECT the “Beastie Boys” mix packages, as it really shows off the capabilities and fun of myRMX. Then select NEW. The software will automatically slide over to the MIX screen as there are no mixLINEs turned on in this mode.

myRMX will ask you if you want a Normal or Long Ringtone. Normal is 8 bars (15 seconds) . . . Long is 16 bars (30 seconds) . . . press Select.

(P.S. If the Tutorial is still ON, one can hit the left soft key again to get a query to turn it OFF).

When in STOP mode on the MIX screen, one can press any key to SAMPLE what is attached to that Key. Press each key . . . 1, 2, 3, 4, 5, 6, 7, 8, 9, *, 0, # . . . etc. to hear the Sample that is attached to that key. Notice that little instrument icons appear in the circles to indicate what instruments, vocals, drums, keyboards, guitar, etc. are attached to that key number. These change from mix package to mix package depending on the artists' music.

Everything in myRMX is simple. Press Down navigation key 33 to START the playback. Press Down again to STOP playback. Press UP key 34 to REWIND, jump back to the beginning of the Ringtone you are mixing (ringtone location is shown on the radar screen in the lower left corner.) Whenever you are Stopped, you can navigate left or right to STEP along the mix and Edit if you wish.

All Keys are LIVE and you can always change anything LIVE while the mixLINEs are moving.

For example, PRESS the 0 Key . . . and you will hear a Drum and Horn sample. Now press DOWN navigation to START your mix. PRESS the 6 Key to hear a “What?” PRESS the 6 Key again . . . and again . . . and again . . . now PRESS the 4 Key to hear a “Ohhh” . . . press any other keys to select other tracks to play . . . you are mixing LIVE and are always in Record mode.

You can press down navigation key 33 and stop the playback at anytime . . . step back left or right . . . and place tracks . . . by dropping in 4's or 6's (or any other key) in between the spaces you have left on the mixLINEs. First press sticks down the track . . . second press removes the track or stops the sample length. This is how you EDIT a Ra . . . Ra . . . Ra . . . . Rock On . . . type of audio segment.

To show that the Mixer is live and always in Record . . . just Press Down on the navigation keypad 33 . . . the tracks start to play and then as fast as you can move your thumb and fingers around the keypad . . . the sounds and mixLINEs on the screen will change. This will sound bad . . . but shows off the sophisticated software and how fast it changes tracks and screen at the same time.

While in the Mix Screen mode, the Left Soft Key has the Snapshot, Clear, Restore menu. If one makes a mess of a mix . . . you can press the left selection key, go to the Snapshot, Clear, Restore mode . . . and press 2, 5, 8, 0 and it will clear ALL tracks . . . then the left selection key again to shut off the menu and take you back to the mix screen.

Snapshot does just that . . . takes a snapshot of that track and then allows you to go play some more to see if you can make a better mix. Restore allows you to go back and UNDO a bad mix and revert back to the last saved Snapshot.

When you think you have a Mix that you like . . . you PRESS the Right Selection Key 28 (to go BACK to the Main Menu page) and then you can select 3 or highlight and Select SAVE and the screen scrolls UP.

You use the T9 keypad to put in your name and the name of the mixTONE that you want to Save as a mixTONE to send to a friend or Save as a Ringtone for your own phone.

Note: It can sometimes take 10-20 seconds to save and may appear that the software is locked up . . . so during a demo just answer “NO” to the save questions and you will go back to the Main Menu page . . . unless you are going to SEND a mixTONE to a friend.

You do NOT have to SAVE a mix. If you are done playing with one set of tracks . . . just go back to the Main Menu, press 1 to go to the Load page . . . select another artist . . . set of tracks . . . and then try mixing different music!

Note: You can also select one of the pre-made Artist mixes and save that out immediately as your Ringtone (SAVE) or take it into the Mixer (MIX) and play or modify the artists mix also.

Note: If you hear a Record Scratching sound, it means you are trying to go to a Mix or Save Screen without a mix package loaded.

Try laying down the drum tracks first and then going back and putting in other instruments. You can mix live, or start with a full artist mix and then modify the tracks.

It can be seen that there is disclosed an entirely new music format, or “mixPACK” that will augment the music listening experience by allowing music to be repackaged, re-sold and then remixed (modified, re-arranged, augmented) by the user right on their mobile phones, handheld devices, and set-top boxes. Prior to now, all music has been linear in form. The invention herein makes music Interactive and lets the user rearrange the song elements to their own liking and allows real-time music modification and re-arranging of music instruments, sounds and vocals. It also allows for editing of music samples, sounds and segments using a game-like interface.

While the apparatus and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A method for utilizing a personal digital assistant to play music thereon including the steps of:
licensing one or more songs from owner of the intellectual property rights in said songs;
creating a mix of said songs in a mixPACK;
providing the personal digital assistant owner with software relating to said mixPACK on said personal digital assistant;
creating a mixture of portions of said songs on said personal digital assistant as a Mix Tone; and
transmitting said newly created MIX TONE to a remote location.

2. The method of claim 1 wherein said personal digital assistant is a cell phone.

3. The method of claim 1 wherein the step of transmitting said newly created Mix Tone includes the step of transmitting said newly created MIX TONE to a third party.

4. The method of claim 3 wherein the step of transmitting said newly created Mix Tone to said third party includes the step of transmitting said MIX TONE to a personal digital assistant owned by said third party.

5. The method of claim 1 wherein the step of transmitting said newly created Mix Tones includes the step of transmitting said newly created MIX TONE to a website set up and run by the creator of said mixPACK.

6. The method of claim 5 including the step of creating a ring tone from the MIX TONE transmitted to said website.

7. A system for utilizing a personal digital assistant to play music thereon including:
a website having downloadable software thereon for allowing a user to create a mix of songs on a personal digital assistant; and
a personal digital assistant for downloading said software and creating a mix of songs thereon in a MIX TONE.

8. The system of claim 7 wherein said personal digital assistant is a cell phone.

9. The system of claim 7 including means on said personal digital assistant for transmitting said newly created MIX TONE to a third party.

10. The method of claim 9 wherein said means for transmitting said newly created Mix Tone to said third party includes means for transmitting said MIX TONE to a personal digital assistant owned by said third party.

11. The method of claim 9 wherein said means for transmitting said newly created Mix Tones includes the step of transmitting said newly created MIX TONE to said website.

12. The method of claim 11 including means for creating a ring tone from the MIX TONE transmitted to said website.
